(19) United States
(12) Patent Application Publication
(10) Pub. No.: US 2010/0091835 A1
(43) Pub. Date: Apr. 15, 2010

(54) Method And System For Processing A Media Stream

(76) Inventor: Robert P. Morris, Raleigh, NC (US)

Correspondence Address: SCENERA RESEARCH, LLC, 111 CORNING RD., SUITE 220, CARY, NC, 27518, US

(21) Appl. No.: 12/250,818

(22) Filed: Oct. 14, 2008

(51) Int. Cl. H04N 11/02

(52) U.S. Cl. 375/240.01; 375/E07.001

(57) ABSTRACT

Methods, systems and computer program products are described for processing a media stream. In one aspect, a method includes detecting, in a first node processing a first media stream, information in the first media stream instructing the first node to listen for a message to be received from a second node, receiving the message from the second node, and adjusting processing of the first media stream based on the received message. The second node generates and sends a message to the first node in response to detecting information in a media stream being processed instructing the second node to send a message to the first node.

### COPYRIGHT NOTICE

A portion of the disclosure of this patent document contains material which is subject to copyright protection. The copyright owner has no objection to the facsimile reproduction by anyone of the Patent and Trademark Office patent file or records, but otherwise reserves all copyright rights whatsoever.

### BACKGROUND

A media stream is a stream of data that is formatted allowing a receiver to begin processing the data before receiving the entire stream. A media stream can include one or more frames where each frame includes data for creating and/or updating a presentation of the media included in the stream. Data in a media stream can be received continuously or non-continuously by a processing node according to the format of the stream, the processing of the data, and/or the network and presented while new data is being delivered or retrieved from a stream provider. A media stream can be comprised of at least one sub-stream that transports a particular type of media content. A multi-media stream is a media stream including more than one type of media content. For instance, a multimedia stream can include a video type sub-stream and an audio type sub-stream.

Known media formats such as MPEG media can include multiple objects and processing information. In some cases, information in one sub-stream can affect the presentation of another sub-stream of the same multimedia stream, for example, when synchronization data in a video sub-stream indicates when a portion of an audio sub-stream should be presented. The processing node can interpret the information and coordinate the presentation of the media sub-streams.

While a sub-stream of a media steam can be affected by another sub-stream of the same media stream, thereby affecting the presentation of the media steam, the media steam is independent of other media streams. That is, media streams currently do not interact with other media streams, particularly across different media players and/or instances of different media stream data. Accordingly, the processing of one media stream by one media processor does not affect the processing of another media stream by another media processor.

### SUMMARY

Methods, systems and computer program products are described for processing a media stream. The methods, systems, and computer program products allow media streams to be responsive to each other and/or allow a set of media streams to be coordinated to accomplish a task, for example, with respect to a group of viewers of the media streams. In one aspect, a method and a computer readable medium containing a computer program, executable by a machine, for processing a media stream includes and comprises executable instructions for detecting, in a first node processing a first media stream, information in the first media stream instructing the first node to listen for a message to be received from a second node, receiving the message from the second node, and adjusting processing of the first media stream based on the received message.

In another aspect of the subject matter disclosed herein, another method and a computer readable medium containing a computer program, executable by a machine, for processing a media stream includes and comprises executable instructions for detecting, in a first node processing a first media stream, information in the first media stream instructing the first node to send a message to a second node, generating the message in response to detecting the information, and sending the message to the second node.

In another aspect of the subject matter disclosed herein, a system for processing a media stream includes a media processing module configured for detecting, in a first node processing a first media stream, information in the first media stream instructing the first node to listen for a message to be received from a second node, a message receiver configured for receiving the message from the second node, and a content handler component configured for adjusting processing of the first media stream based on the received message.

In another aspect of the subject matter disclosed herein, another system for processing a media stream includes a media processing module configured for detecting, in a first node processing a first media stream, information in the first media stream instructing the first node to send a message to a second node, a content handler component configured for generating the message in response to detecting the information, and a message transmitter component configured for sending the message to the second node.

### BRIEF DESCRIPTION OF THE DRAWINGS

Advantages of the subject matter claimed will become apparent to those skilled in the art upon reading this description in conjunction with the accompanying drawings, in which like reference numerals have been used to designate like elements, and in which:

FIG. 1 is a flow diagram illustrating a method for processing a media stream according to an exemplary embodiment;

FIG. 2 is a block diagram illustrating a system for processing a media stream according to an exemplary embodiment;

FIG. 3 is a block diagram illustrating another system for processing a media stream according to another exemplary embodiment;

FIG. 4 illustrates a network in which a system for processing a media stream can be implemented;

FIG. 5 is a block diagram illustrating another system for processing a media stream according to another exemplary embodiment; and

FIG. 6 is a flow diagram illustrating another method for processing a media stream according to another exemplary embodiment.

### DETAILED DESCRIPTION

The subject matter presented herein allows media streams to be responsive to each other and/or allows a set of media streams to be coordinated to accomplish a task, for example, with respect to a group of viewers of the media streams. Various aspects will now be described in connection with exemplary embodiments, including certain aspects described in terms of sequences of actions that can be performed by elements of a computing device or system. For example, it will be recognized that in each of the embodiments, at least some of the various actions can be performed by specialized circuits or circuitry (e.g., discrete and/or integrated logic gates interconnected to perform a specialized function), by program instructions being executed by one or more processors, or by a combination of both. Thus, the various aspects can be embodied in many different forms, and all such forms are contemplated to be within the scope of what is described.

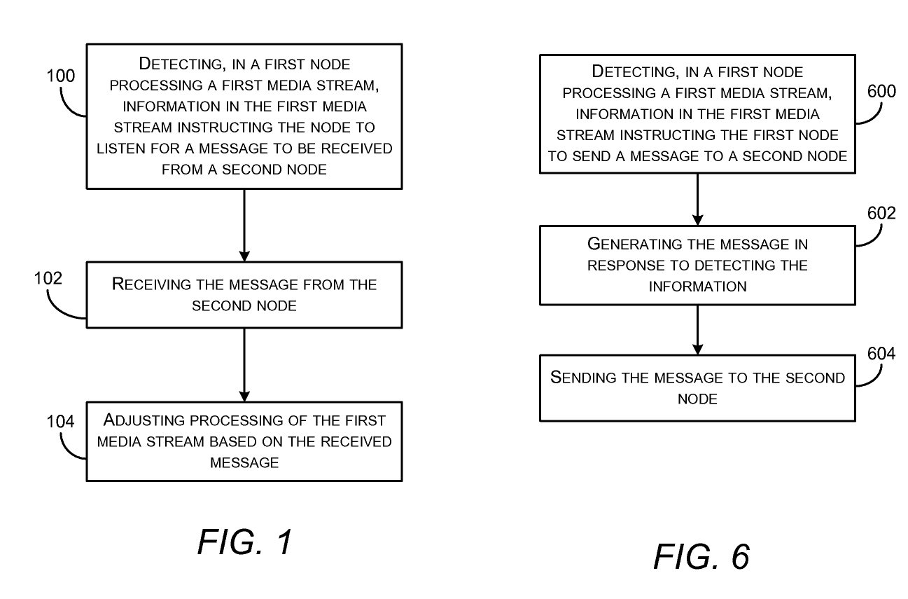

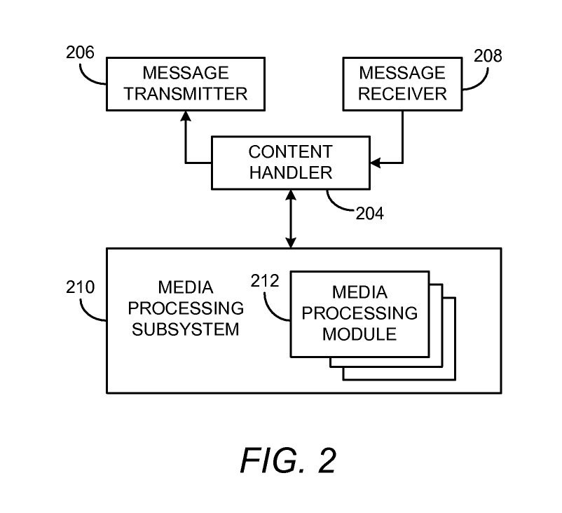

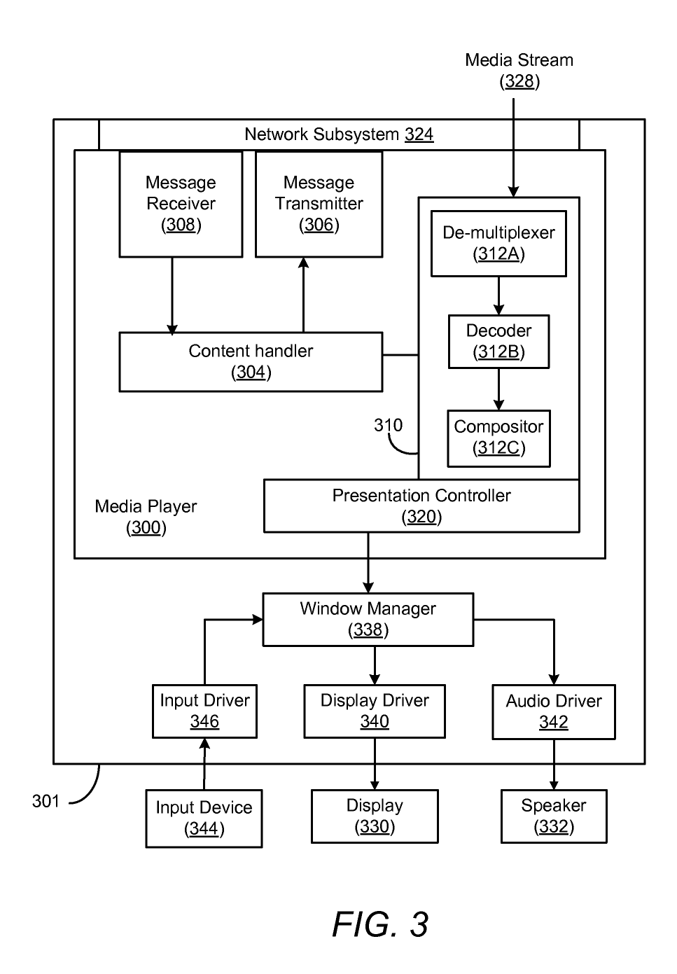

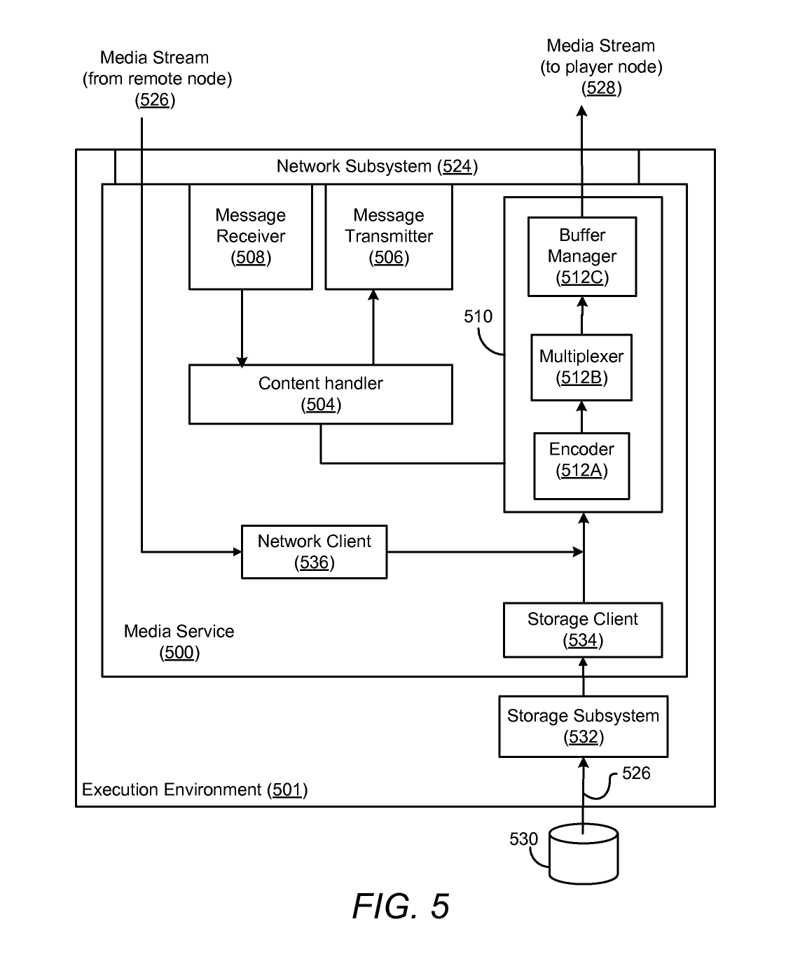

FIG. 1 is a flow diagram illustrating a method for processing a media stream according to an exemplary embodiment. FIGS. 2, 3, and 5 are block diagrams illustrating systems for processing a media stream according to embodiments of the subject matter described herein. In particular, FIG. 2 illustrates an arrangement of components configured for processing a media stream, while FIG. 3 and FIG. 5 illustrate the components of FIG. 2 and/or their analogs adapted for operation in execution environments provided by media processing nodes for processing a media stream. The method illustrated in FIG. 1 can be carried out by, for example, at least some of the components in each of the exemplary arrangements of components illustrated in FIGS. 2, 3, and 5.

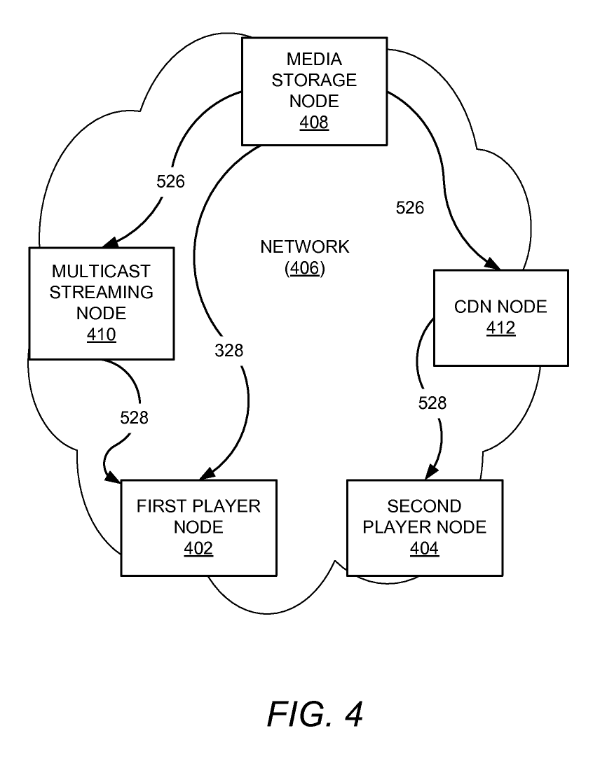

FIG. 2 illustrates components that are configured to operate within an execution environment hosted by a node and/or multiple nodes, as in a distributed execution environment. For example, in FIG. 4, which illustrates a plurality of nodes communicatively coupled to one another via a network 406, such as the Internet, media player nodes 402, 404 and media streaming nodes 408, 410, 412 (collectively referred to as “media processing nodes”) can be configured to provide respective execution environments configured to support the operation of the components illustrated in FIG. 2 and/or their analogs. Exemplary media processing nodes can include desktop computers, servers, networking nodes, notebook computers, PDAs, mobile phones, and digital image capture devices.

An exemplary execution environment can include a memory for storing components and an instruction processing component, such as processor and/or a digital signal processor (DSP), for processing instructions and any data associated with the operation of the components illustrated in FIG. 2. The components illustrated in FIG. 2, and functionally analogous components, each can require additional hardware and/or software subsystems according to their particular operational requirements. For example, a network subsystem can be included in the execution environment for enabling communication between nodes over the network 406. An operating system, a persistent data storage subsystem, a memory management subsystem, and/or a process scheduler are other examples of components that can be required for various adaptations of the components illustrated in FIG. 2 and their functional analogs for performing the method in FIG. 1.

Illustrated in FIG. 3 is a media player 300 including the components illustrated in FIG. 2 adapted for operating in an execution environment 301. The execution environment 301, or an analog, can be provided by a node such as the first player node 402 and/or the second player node 404. Alternatively or in addition, as illustrated in FIG. 5, the components illustrated in FIG. 2 can be adapted for operation in a media service 500 in an execution environment 501 provided by a media processing node. In this embodiment, the execution environment 501, or an analog, can be provided by a node such as a media storage node 408, a multicast streaming node 410, a content delivery network (CDN) node 412, and/or a node hosting another type of media streaming service.

With reference to FIG. 1 in block 100, information in a first media stream instructing a first node to listen for a message to be received from a second node is detected in the first node processing the first media stream. In one embodiment, the second node can be processing a second media stream, which can be different from the first media stream or another instance of the first media stream. Accordingly, the first and second media streams can interact with one another across multiple media processing nodes.

According to an exemplary embodiment, a system for processing a media stream includes means for detecting, in the first node processing the first media stream, the information. For example, FIG. 2 illustrates a plurality of media processing modules 212 in a media processing subsystem 210. In one embodiment, a media processing module 212 can be configured for detecting, in the first node processing the first media stream, information in the first media stream instructing the first node to listen for a message to be received from a second node.

According to an exemplary embodiment, the media processing subsystem 210 includes a plurality of the media processing modules 212 configured to interoperate to process the media stream. One or more media processing modules 212 operating in the first node can be configured to detect the information, for example, while the first media stream is being processed by the media processing subsystem 210.

According to one embodiment, the components illustrated in FIG. 2, including the media processing subsystem 210, can be adapted to operate in a media player 300 in an execution environment 301 provided by a media stream processing node, such as the first player node, e.g., 402. The media player 300 can receive a media stream 328 via a network interface of a network subsystem 324 provided by the execution environment 301.

In one embodiment, the media stream 328 can be transmitted over a network 406 from a media storage node 408, and/or a proxy for the media storage node 408, such as a multicast streaming node 410 or a content delivery network (CDN) node 412. The CDN node 412 can be configured to maintain a cache storing at least a portion of the media stream 328 for transmitting to the first player node 402, the second player node 404, and/or another node (not shown) for processing. Alternatively, the media player 300 can receive the media stream 328 from another node, such as a peer node in a peer-to-peer (P2P) network or another player node, e.g., the second player node 404. In another embodiment, the media stream 328 can be read from a local or remote data store (not shown) and/or provided by another instance of an application (not shown) operating in the execution environment 301.

The media stream 328 can be transmitted in a format suitable for presentation, but is typically transmitted in a format suited for sending over the network 406. The media stream 328 can include frames that can be multiplexed into portions corresponding to one or more sub-streams included in the media stream 328. The data can further be encoded for transmission. For example, media stream data transmitted over the network 406 can be in a compressed format. When the media stream 328 is received, the network subsystem 324 can be configured to route media stream data to the media player 300 for processing for presentation on one or more presentation devices, such as a display 330 and/or a speaker 332.

In one embodiment, the media player 300 includes a media processing subsystem 310 for processing the media stream 328. As stated above, the media processing subsystem 310 includes at least one media processing module, such as a de-multiplexer 312A, at least one decoder 312B, and a compositor 312C. The de-multiplexer 312A can be configured to separate media stream data 328 according to one or more sub-streams, headers (if any), and/or trailers (if any). One or more media processing modules can process the media stream 328 prior to processing by the de-multiplexer 312A, if necessary, for example to decompress and/or decrypt the received media stream data 328. The separation can be performed by the de-multiplexer 312A for each frame in the media stream data 328.

The de-multiplexer 312A can be further configured to provide data for each separated portion of each sub-stream to a decoder 312B compatible with the sub-stream type. Type can be based on a data format and/or a purpose of a sub-stream. Accordingly, the media player 300 can include and/or have access to at least one decoder 312B for each of video data, audio data, metadata, markup-based language data, such as X3D formatted data, and/or executable data such as script data and the like. Each decoder 312B can be configured to decode a sub-stream based on a known format or schema of the data in the sub-stream. Further, a decoder 312B processing a sub-stream can be configured to convert a sub-stream from a transport format to a format suitable for processing via, for example, decryption and/or decompression. A decoder 312B can be configured to prepare sub-stream data for presentation by the compositor 312C. A decoder 312B can invoke an external content handler 304 as illustrated in FIG. 3 and/or can include and/or operate as a content handler.

Decoded data from one or more sub-streams can be provided to the compositor 312C, which can be configured to reconstruct and/or generate frames from a portion of each decoded sub-stream. Alternatively or additionally, the compositor 312C can be configured to orchestrate the presentation of frame data by controlling one or more content handlers 304 configured to present their sub-stream data. The compositor 312C can also be configured to process synchronization data in the media stream 328 to synchronize the presentation of the various sub-streams of the media stream 328. The media stream 328 can include a synchronization sub-stream. Alternatively or in addition, each particular sub-stream can include synchronization data according to its content for synchronization with other sub-streams including corresponding synchronization data. Alternatively, synchronization data can be included in header and/or trailer data. Sub-stream data from one or more decoders 312B can be received and/or otherwise controlled by the compositor 312C for presentation according to any synchronization data.

As described above, the media player 300 can include at least one content handler 304 configured for processing a particular type of content for presentation. Multiple content handlers 304 can be provided to process different types of data and/or a single content handler 304 can be configured to process more than one type of media stream content. For example, a video sub-stream can be provided to a content handler 304 configured to process a particular type of video data corresponding to the video sub-stream. Alternatively, a video content handler 304 can be configured to process multiple video data formats identifiable by MIME type. Additionally or alternatively, a content handler 304 for ECMAScript or other executable data type, and/or one or more content handlers 304 configured to process one or more types of markup language based data can be provided.

According to one embodiment, the compositor 312C can present a representation of and/or otherwise process each sub-stream portion of a frame in a synchronized manner according to the configuration of each frame, and the configuration of the compositor 312C. The compositor 312C can be configured to receive output data from one or more decoders 312B processing one or more sub-streams. The compositor 312C, alternatively or additionally, can be configured to detect a script portion or other executable portion of a frame and to provide the detected script instructions to a compatible script content handler 304 and/or decoder 312B for execution in synchronization with other sub-stream processing. Similarly, the compositor 312C can detect a markup-based language portion of a frame and can provide the markup to a compatible markup content handler 304 and/or decoder 312B for processing according to the synchronization specified in the media stream 328 and according to the configuration of the compositor 312C.

The content handler 304 and/or decoder 312B can be configured to provide processed data to the compositor 312C for presenting via a presentation controller 320 and/or can be configured to present processed data as managed by the presentation controller 320, for example, by interoperating with the presentation controller 320 without passing the processed data through the compositor 312C. The presentation controller 320 can be configured to interoperate with a window manager 338 provided by the execution environment 301.

The window manager 338 can provide access to various device drivers and hardware adapters to access output devices. For example, a display driver 340 can be configured for presenting any visual data included in the media stream 328 on the display 330 via a graphics adapter (not shown), and an audio driver 342 can be configured for presenting any audio data included in the media stream 328 on the speaker 332 via a sound card (not shown). In addition, the window manager 338 can receive input data from an input device 344 via a compatible input driver 346. The window manager 338 can determine to which application and/or application component to provide the input data for processing.

In one embodiment, the media stream 328 or a sub-stream of the media stream 328 can include the information instructing the first node to listen for a message to be received from a second node. The information can, in one embodiment, include executable data, such as a script instruction. For example an xmlHTTPRequest object supported by many scripting environments can be included in a script sub-stream along with parameters and additional instructions for sending a message to the second node. Exemplary media formats capable of including a scripting language instruction include Advanced Systems Format (ASF) and MPEG-4. MPEG-4 Binary Format for Scenes (BIFS) supports a script stream (ECMAScript). Exemplary scripting languages includable in a media stream include Avisynth compatible with any media player that supports audio video interleave (AVI) formatted streams, Adobe Action Script, ECMAScript, Standard Multimedia Scripting Language (SMSL), Lingo, and AVI-Mux. Analogously, the information can include any representation of a set of executable instructions; such as machine code instructions or byte code instructions, such as Java byte code.

Additionally or alternatively, the information can include non-executable data, such as an element of a markup based language, binary formatted data, and the like. For example, X3D is an ISO standard XML-based markup language for representing 3-D computer graphics includable in an MPEG media stream. Synchronized Multimedia Language (SMIL) is another exemplary markup-based language providing instructions for multimedia presentation includable in a media stream. A markup-based language sub-stream can include instructions defined in the particular markup-based language of the sub-stream as commands to listen for a message to be received from a second node.

In one embodiment, the information, along with instructing the first node to listen for the message, can identify the content of the message to be received, a format of the message, and/or the second node. Moreover, the information can identify an attribute of time relating to the receiving of the message. For instance, the first node can be instructed to listen for the message after a specified time period has elapsed or within a predetermined time period. In another embodiment, the information can instruct the first node to establish a subscription for the message, to send a request for the message, and/or to open a communication endpoint for listening for the message from the second node. Alternatively, the information can instruct the first node to send a get/fetch message to retrieve information and listen for a response. In another alternative, the information can instruct listening for an unsolicited notification.

According to an exemplary embodiment, during the processing of the first media stream, any of the media processing modules 312A-C described above can be configured to detect and/or provide for detecting the information in the first media stream instructing the first node to listen for a message to be received from the second node. Such detecting can be performed by, for example, executing an instruction included in the first media stream and/or executing an instruction included in the detecting media processing module 312A-C. When the detected information includes a script instruction or an element of a markup based language, for example, the compositor 312C can be configured to detect the script or markup and to provide the script or markup to a compatible content handler 304 configured to detect and process the information by processing the executable data, e.g., script instructions, or non-executable data, e.g., markup instructions, based on a schema defining the markup based language's syntax and semantics.

In Example 1, below, information in a first media stream comprises XML-based markup including an element instructing the first node processing the first media stream to listen for a message from an identified principal.

### EXAMPLE 1

```
<message>
  <from principal=”xmpp://%user%”/>
  <notification/>
</message>
```

The principal is identified using a URL having an XMPP scheme. The protocol of the message can also be identified by the URL scheme identifier.

Example 1 illustrates a principal identifier with a variable included, “%user%”. The markup content handler 304 and/or a media processing module, e.g., the decoder 312B and/or the compositor 312C, can be configured to detect the variable and, in this particular example, replace the variable with an XMPP identifier of a watching principal such as a user. The notification element can indicate an instruction for listening for a notification. A default can indicate the notification is to be received from one or more of the identified user's friends allowing a watcher to track the status of principals identified in a friends list at specified locations in the media stream 328.

As stated above, the components illustrated in FIG. 2 for processing a media stream can also be adapted for operation within a media processing node, shown in FIG. 5, that provides an execution environment 501 hosting a media service 500. In particular, the media service 500 can include a media processing module 512 in a media processing subsystem 510 configured to detect the information in the media stream instructing the node to listen for a message to be received from another node. The media processing node hosting the media service 500 can be, in one embodiment, the media storage node 408, where a media stream 526 can be stored in a data store 530 and can be retrieved by the media processing subsystem 510 for processing and streaming to a recipient.

In one embodiment, a storage client 534 can be configured to interoperate with a storage subsystem 532 included in the execution environment 501. The storage subsystem 532 can be operatively coupled to one or more drivers providing communications and control of storage devices, such as the data store 530. The media service 500 can read the media stream 526 stored in the data store 530 via an interface of the storage subsystem 532. The storage client 534 can be configured to provide the data representing the media stream 526 to the media processing subsystem 510 for processing and for sending over the network 406 to the recipient, such as the media player 402. A recipient can request a particular media stream 526 and/or a media stream 526 can be sent by the media service 500 to a recipient unsolicited and/or at the request of a node other than the recipient.

Alternatively or additionally, the media processing node hosting the media service 500 can be a multicast streaming service or a CDN service as hosted by the multicast streaming node 410 or the CDN node 412, respectively, each providing a proxy service. As a proxy service, the media service 500 can receive a media stream 526 sent over the network 406 via a network subsystem 524 operatively coupled to the network 406. The network subsystem 524 can route received media stream data to a port opened by the media service 500 for receiving a connection request and/or datagram. Regardless of the transport and/or application protocol provided by the network subsystem 524 to receive a media stream, the media service 500 can include a network client 536 configured to interoperate with an interface provided by a layer of a network stack included in the network subsystem 524.

According to an exemplary embodiment, the media processing subsystem 510 can have a plurality of media processing modules, including at least one encoder 512A, a multiplexer 512B, and a buffer manager 512C. As with decoders 312B in media players 300, the media service 500 can include at least one encoder 512A, for example, for each of video data, audio data, metadata, markup-based language data, and/or script data as well as other types of executable data. Some encoders 512A can encode media stream data regardless of the data's attributes. For example, all the data in a media stream can be encrypted by a single encoder 512A configured to encode the data into an encrypted data stream. Other encoders 512A can be provided that process only a portion of the media stream's data. Media stream data can be provided to an encoder 512A based on the data's MIME type, for example.

An encoder 512A can be supported by a compatible content handler 504. The content handler 504 can be invoked by the corresponding encoder 512A to examine the data processed by the encoder 512A and to perform operations. The content handler 504 can, for example, decode sub-stream data, if necessary, process the data, then encode the data or provide the decoded data to the encoder 512A for encoding. Although shown as a separate module from the encoder 512A, the content handler 504 can also be integrated within the encoder 512A.

In one embodiment, the received media stream 526 can be processed by the storage client 534 and/or network client 536 to identify one or more sub-streams included in the media stream 526. The storage client 534 and/or network client 536 can be configured to detect each sub-stream and determine its type. The storage client 534 and/or the network client 536 can be further configured to provide a sub-stream to a stream encoder 512A configured to encode the sub-stream of the type determined.

Encoded data can be associated with a frame identified in the sub-stream and/or a frame identified in the media stream 526 external to the sub-stream. Encoded data and frame information can be provided to the multiplexer 512B. The multiplexer 512B can be configured to multiplex encoded data from one or more sub-streams into frame data representing a frame in a format suitable for transmission over a network. The multiplexer 512B as illustrated in FIG. 5 provides portions of the multiplexed media stream to the buffer manager 512C, which can interoperate with the network subsystem 524 to transmit buffered data of the media stream 528 over the network 406 to the recipient.

According to an exemplary embodiment, the received media steam 526 can include the information instructing the processing node to listen for a message from a second node, as described above. The information can be included in a sub-stream of the media stream 526 and/or in a header or other portion not included in a sub-stream of the media stream 526. In one embodiment, any of the media processing modules 512A-C in the media processing subsystem 510 can be configured to detect and/or provide for detecting the information.

For example, the multiplexer 512B can detect a type of encoded data, e.g., encoded video data, received from an encoder 512A. Based on the detected type, the multiplexer 512B can process the data internally and/or provide at least a portion of the encoded data to a component compatible with the detected data type for processing. In one embodiment, during such processing, the multiplexer 512B can be configured to detect the information, e.g., script data, in the media stream. The multiplexer 512B can be configured to execute the script and/or provide the script a compatible script processor, such as a compatible script content handler 504.

In Example 2, below, information in a first media stream comprises XML-based markup that instructs a message to be fetched from a peer media server in its cluster.

### EXAMPLE 2

```
<message>
  <recipient=”cluster”/>
  <fetch>
    <status>
      <load/>
    </status>
    <queue/>
  </fetch>
</message>
```

In the above example, the recipient is identified with a reserved keyword, “cluster” according to a schema defining the markup-based language. The keyword “cluster” is defined to indicate the one or more media servers providing the service provided by the media service 500. A “cluster” can indicate an address of a specific node, can be a broadcast address, or can represent a proxy such as a publish-subscribe server. Status information including a current measure of work load of each member of the cluster is requested along with a list of streaming requests known to each peer and queued by each peer for processing.

Similar markup can be encoded into the media stream at other locations resulting in repeated listening for messages. The particular message can provide information for load balancing among the nodes of a cluster. Specific media stream information can be provided so that the load balancing, as indicated by the information in a specific media stream, is checked and readjusted based on the particular media stream being served.

Script and/or markup-base language can be combined in a sub-stream and/or can be received in separate sub-streams. Any attribute detectable by the media player 300 or the media service 500 can be processed along with a sub-stream affecting an indication of whether or not to send a message. Other exemplary attributes include a detected input, a hotspot, a player attribute, content, an identified user, a compositor attribute, content included in a previous and/or subsequent frame, and/or the content of another sub-stream.

In one embodiment, the second node can be the same node as the first node when the second media stream is a separate media stream or a different instance of the same media stream. The first media stream and the second media stream are not sub-streams in a single instance of the same media stream.

Referring again to FIG. 1, once the information is detected and the node is instructed to listen for the message, the process continues in block 102 by receiving the message from the second node. According to an exemplary embodiment, the system for processing the media stream includes means for receiving the message from the second node. For example, FIG. 2 illustrates a message receiver component 208 configured for receiving the message from the second node.

In one embodiment, when the detected information instructing the node to listen for a message is processed by a media processing module 212, e.g., by the compositor 312C, the multiplexer 512B, and/or the content handler 304, 504, an instruction to listen for the message can be passed to the message receiver component 208. The message receiver component 208 can be configured to listen for a response to a request polling for a message from the second node, to listen for a solicited message, such as a requested response, and/or to listen for an unsolicited message, such as event or notification message. An identifier for a listening communication endpoint can be provided and/or can be retrieved by the message receiver component 208 from a configuration store (not shown).

According to one embodiment, the component processing the detected information can invoke a message transmitter component 206 to open a communication endpoint assigned for exchanging messages formatted according to a particular application or network protocol as configured and/or indicated for receiving the message. If a reference to a sender's address can be provided, such as when the message receiver 208 is instructed to listen for a response to a request, the message receiver 208 can be configured to resolve the reference to a usable address. The message transmitter 206 can create a connection with a communication endpoint provided by the second node or a proxy for the second node, determine an existing connection, and/or use a connectionless protocol, such as UDP, to send a request and/or subscription.

For example, in the media player 300 or the media service 500, at least one of the media processing modules, e.g., the compositor 312C, the multiplexer 512B, and/or the content handler 304, 504, can process the detected information in the media stream or a sub-stream of the media steam. In one embodiment, the information can include script instructions in a particular scripting language of a sub-stream configured to listen for a message from a second node, which can be processing a second media stream. The script instructions can establish a listening end-point directory and/or can call another component providing for information instructing the other component to listen for a message. Alternatively, the instructions can send an indication or call another component, such as the message transmitter 306, 506, providing information instructing the other component to generate and/or send a request message via a network subsystem 324, 524 according to a protocol supported by the message transmitter 306, 506 and/or the network subsystem 324, 524. In response to sending the request, the message receiver 308, 508 can be instructed to listen for a response to the request.

In addition to providing the instruction to listen for the message, the detected information can also identify, in one embodiment, the second node and an indication of one or more operations to perform when the message is ready to be received. For instance, the content handler 304, 504 can invoke the message transmitter 306, 506 to send a message for establishing a subscription to be notified when the message is available. The subscription message can be sent to a subscription server, such as a publish-subscribe server and/or the second node, over a network via the network subsystem 324, 524. The content handler 304, 504 can be configured further to invoke the message receiver 308, 508 to establish a communication endpoint, such as a TCP and/or UDP port, to listen for a notification message from the second node. In addition, the content handler 304, 504 can provide information to the message receiver 308, 508 to listen for one or more unsolicited, asynchronous messages from the second node.

According to an exemplary embodiment, the message receiver 208 can be configured to receive and to prepare the message from the second node according to a particular application protocol, such as HTTP or one of its derivative protocols, e.g., SOAP; XMPP or one of its derivative protocols, e.g., a presence protocol included in XMPP-IM; and/or any suitable application protocol. More than one message receiver 208 can be provided based on, for example, supported application protocols, message payload formats, recipients, and/or security requirements.

Alternatively or additionally, the message receiver 208 can be configured to receive and to prepare the message according to a network protocol such as TCP, UDP, or any other protocol suitable for transmitting data between a first node and a second node. Preparation can include reconstructing the message from packets, stripping off a header and/or a trailer, decompressing or otherwise decoding the message data for processing, decrypting, and/or managing session or state information. In various alternatives, some of the mentioned processing can be performed by components other than the message receiver 208. For example, a TCP layer in a network stack in the network subsystem 324, 524 can handle breaking a message into packets if required by the length of the message. The message receiver 208 can be configured to interoperate with the network subsystem 324, 524 to receive the message via the network 406 from the second node.

According to one embodiment, the second node can be any node accessible by the first node. For example, the first player node 402 can receive the message from the media storage node 408, the multicast server node 410, the CDN node 412, the second player node 404, and/or any other node operatively coupled to the network 406. Similarly, the media storage node 408 can receive a message from the first player node 402, the multicast streaming node 410, the CDN node 412, the second player node 404, and/or any other node operatively coupled to the network 406.

Referring again to FIG. 1, the processing of the first media stream is adjusted based on the received message in block 104. According to an exemplary embodiment, the system for processing a media stream includes means for adjusting the processing of the first media stream based on the received message. For example, FIG. 2 illustrates a content handler 204 configured for adjusting processing of the first media stream based on the received message.

According to an exemplary embodiment, in response to receiving the message, the message receiver 208 can provide the message to a compatible content handler 204. In one embodiment, more than one content handler 204 can be provided based on, for example, application protocols supported, message payload formats, recipients, and/or security requirements. Accordingly, the message receiver 208 can pass the message to the compatible content handler 204 based on an attribute of the data, e.g., MIME type, or according to instructions received from a media processing module 212 and/or the content handler 204.

The content handler 204 can be configured to process at least a portion of a received message according to a particular application protocol, such as HTTP or one of its derivative protocols, XMPP or one of its derivative protocols, or any suitable application protocol. In one embodiment, the content handler 204 can process the message and can adjust the processing of the first media stream based on the content of the message. In addition, the content handler 204 can adjust the processing of the first media stream based on other factors such as a sender of the message, a content type of a portion of the message, an attribute of the first media stream, an attribute of a second media stream processed on a second node, a user, and/or any other accessible attribute.

For example, the content handler 204 can be configured to adjust the processing of the first media stream by presenting the message content, e.g., text messages, in and/or along with the media stream. Alternatively or additionally, a media object, such as a graphic overlay or a portion of an audio and/or video stream, can be included in the message, and the content handler 204 can be configured to present and/or incorporate the media object in and/or along with at least a portion of the first media stream being processed. Alternatively, the message can include a command to adjust the speed, size, and/or other attribute associated with the processing of the first media stream, such as terminating or pausing the processing of the first media stream. The received message can also include other objects and instructions that can alter other processing in the first node, e.g., providing additional resources for processing the first media stream, and the like. In one embodiment, for example, the message can include instructions altering a source of the first media stream.

In a media player 300 or media service 500, some of the adjusting of the processing can be done by components other than a content handler 304, 504. For example, a number of components can be involved in adding, removing, and/or modifying a media object in the first media stream. The content handler 304, 504 can be configured to interoperate with any media processing module 312A-C, 512A-C, the presentation controller 320, the message transmitter 306, 506, and/or other accessible components configured to perform processing associated with adjusting the processing of the first media stream 328, 526.

According to one embodiment, the media stream can be adjusted as it is being received, sent, and/or processed for sending, storing, presenting, and the like. For example, the media storage node 408 can receive a message from the first player node 402 including information to adjust the serving of the first media stream 528 by sending a copy of the first media stream 528 to the second node 404 to be presented. The sending of the first stream 528 and its copy can be synchronized or unsynchronized based on the message received by the media storage node 408 and/or a configuration of the media storage node 408.

In another example, a message sent from the first player node 402 to the second player node 404 can include at least a portion of the first media stream 328 for processing by the second player node 404. The second player node 404 can be playing a second media stream. One or more content handlers 304 in the second player node can process the received first media stream data and adjust the processing of the second media steam by moving its presentation and/or resizing its presentation to accommodate the presentation of the first media stream 328.

In another example, CDN nodes 410 processing media streams 526 can exchange messages in order to provide a particular media stream processed by one or more CDNs nodes 410 to a requesting player node 402 as efficiently as possible. In addition, the multicast streaming node 410 can receive a message from the first player node 402 processing the first media stream, the message including performance and/or quality of service information. The multicast streaming node 410 can respond by adding another media storage node 408 as a source for the first media stream in order to guarantee that the multicast streaming node 410 will have the content to be multicast prior to the time it is required to be sent for multicast in order to preserve proper timing of the presentation of the first media stream. The examples provided are intended to be suggestive and are not meant to be exhaustive.

FIG. 6 is a flow diagram illustrating a method for processing a media stream according to another aspect of the subject matter described herein. The method illustrated in FIG. 6 can be carried out by, for example, some or all of the components illustrated in FIG. 2 adapted to operate in a compatible execution environment provided by some or all of the components of the arrangements illustrated in FIG. 3 and FIG. 5.

As stated above, the components illustrated in FIG. 2 are configured to operate within an execution environment hosted by a node and/or multiple nodes. For example, media processing nodes, such as player nodes 402, 404 and media streaming nodes 408, 410, 412, can be configured to provide an execution environment, described above, that can support the operation of the components illustrated in FIG. 2 and their various analogs.

Referring to FIG. 6, in block 600, information in a first media stream instructing a first node to send a message to a second node is detected in the first node processing the first media stream. As indicated above, the second node can be processing a second media stream, which can be different from the first media stream or another instance of the first media stream, or performing some other function. Accordingly, the first and second media streams can interact with one another across multiple media processing nodes and/or across processes within a single execution environment provided by a node or nodes

According to an exemplary embodiment, a system for processing a media stream includes means for detecting, in a first node processing a first media stream, information in the first media stream instructing the first node to send a message to a second node. For example, a media processing module 212 included in the media processing subsystem 210 can be configured for detecting, in a first node processing a first media stream, information in the first media stream instructing the first node to send a message to a second node.

In one embodiment, the information instructing the first node to send a message to the second node can include executable data, such as a script instruction, and/or non-executable data, such as an element of a markup based language. The information can identify the content of the message to be sent, a format of the message, the second node, a proxy for routing the message to the second node and/or a second media stream being processed by the second node. Moreover, the information can identify an attribute of time relating to the generating and sending of the message. For instance, the first node can be instructed to generate and/or send the message after a specified time period has elapsed and/or within a predetermined time period.

Additionally, the information can include any attribute, which when processed, can affect whether the message is generated and/or sent to the second node, as well as affecting the generation and/or sending of the message. For example, the information can specify and/or include an expression that is to be evaluated and that determines whether the message should be generated and/or sent to the second node. In one embodiment, the expression can include a variable which identifies a value based on a factor, such as, for example, the content of the first media stream, a received input, a hotspot, media player or media service attributes, an identified user, the content in a previous and/or subsequent frame, and/or the content of another sub-stream. In one embodiment, the generating and/or sending of the message can be based on the evaluation of the expression when the variable is set to the identified value.

As indicated above, the components illustrated in FIG. 2 can be included in the media player 300 hosted by the execution environment 301 provided by the first player node 402, or in the media service 500 hosted by the execution environment 501 provided by the media storage node 408, the multicast stream node 410, and/or the CDN node 412. According to an exemplary embodiment, during the processing of the first media stream by the media player 300 or the media service 500, any of the media processing modules 312A-C, 512A-C described above can be configured to detect the information in the first media stream instructing the first node to send a message to the second node. Such detecting can be performed by, for example, executing an instruction included in the first media stream and/or an instruction included in the detecting media processing module 312A-C, 512A-C.

For example, when the detected information includes a script instruction or an element of a markup based language, a compatible decoder 312B in the media player 300 or a compatible encoder 512A in the media service 500 can be configured to detect the script instruction or markup instruction. The instruction can be provided to a compatible content handler 304, 504 configured to detect and process the information by processing the executable data, e.g., script instructions, or non-executable data, e.g., markup instructions, based on a schema defining the markup based language's syntax and semantics.

Example 3 below includes detectable information comprising XML-based markup that instructs a processing node to send a message to an identified recipient.

### EXAMPLE 3

```
<message>
  <to recipient=”source”/>
  <event>
    <presented/>
    <resource>
      <id>AA7-6235-C</id>
    </resource/>
  </event>
</message>
```

The recipient is identified using a reserved keyword, “source” according to a schema defining the markup-based language. The keyword “source” is defined to indicate a sender or source of the media stream. The markup is included in a markup language sub-stream portion of a frame with a content portion identified by value of “AA7-6235-C”. The message sent is an event message as indicated by an <event> element. The event type is “presented” defined to indicate that the resource identified in the event has been presented by the sender of the message. When a frame including the content identified by “AA7-6235-C” includes a markup portion as in Example 3, the markup portion is detected by the markup decoder 312B or a markup encoder 512A, and/or a compatible markup language content handler 304, 504.

In Example 4 below, XML-based markup instructs a message to be sent to an identified recipient. The recipient is identified using a reserved keyword, “target” according to a schema defining the markup-based language. The keyword “target” is defined to indicate the receiver or target of the media stream. For example, the player node 402 can be the receiver of a media stream sent by the CDN 412. The markup can be included in a script and markup language sub-stream portion of a frame with a content portion in another sub-stream identified by a value of “AA7-6235-C”.

### EXAMPLE 4

```
<message>
  <to recipient=”target”/>
  <event>
    <advertisement/>
    <resource>
      <frame id=”20193”>
        <id>AA7-6235-C</id>
      </frame>
    </resource/>
  </message>
```

The message sent is an event message as indicated by an <event> element. The event type is “<advertisement>” defined to indicate that the resource identified in the event is an “advertisement”. The message can be sent prior to sending of the identified frame by the sending node allowing the message to be received by the sender prior to arrival of the frame. In an exemplary scenario, a receiving media player 300 can provide an indication to a viewer and/or listener of the stream that an advertisement is about to be presented.

Referring again to FIG. 6, in response to detecting the information, a message is generated in block 602. According to an exemplary embodiment, a system for processing a media stream includes means for generating a message in response to detecting the information. For example, the content handler 204 can be configured for generating a message in response to detecting the information.

According to one embodiment, when the media processing module 212 detects the information instructing the node to send a message to the second node, the media processing module 212 can pass the information to a compatible content handler 204 for processing. For example, in the media player 300, a decoder 312B can detect instructions in a script language that generates a message, and can pass the instruction to a compatible content handler 304 for processing. Similarly, in the media service 500, an encoder 512A can pass the detected instruction to a compatible content handler 504. In one embodiment, the content handler 304, 504 can be configured to generate the message and/or to invoke another component for generating the message.

In one embodiment, the instruction can include a markup language element(s) associated with an operation to generate and send a message. A library of routines can be provided including a routine configured to perform a message generating operation. The routine(s) can be included in the content handler 304, 504, and/or can be provided as a separate component and/or in a separate component. In one embodiment, a content handler 304, 504 can be provided and explicitly configured for performing at least one of the routines. In another embodiment, more than one content handler 304, 504 can interoperate to generate the message, for example, when script and markup elements are provided in separate sub-streams and/or or included in a single stream.

As indicated above, the detected information can identify the content of the message and the recipient of the message, i.e., the second node. In other embodiments, the content and recipient of the message can be provided by other sources, such as an application, user input, and/or a message from another node. The content, in one embodiment, can include information for altering the processing of the second media stream by the second node. For example, the message can include a command to adjust a speed, size, and/or other attribute associated with the processing of the second media stream, such as terminating or pausing the processing of the second media stream. The message can also include other objects and instructions that can alter other processing in the second node, e.g., providing additional resources for processing the second media stream, and the like. In one embodiment, for example, the message can include instructions altering a source of the second media stream.

Referring again to FIG. 6, the message is sent to the second node in block 604. According to an exemplary embodiment, a system for processing a media stream includes means for sending the message to the second node. For example, the message transmitter 206 can be configured for sending the message to the second node.

According to one embodiment, the content handler 204 can provide the generated message to the message transmitter 206 along with destination information, such as a DNS name, an IP address, and/or a reference to a network identifier. The message transmitter 206 can be configured to prepare the message according an application or network protocol configured for transmitting the message.

When a reference to a destination address is provided, the message transmitter 206 can be configured to resolve the reference to a usable address. For example, the message transmitter 206 can invoke a DNS client with a DNS name and receive an IP address matching the name in response. The IP address can be used as a destination address for the message. The message transmitter 206 can create a connection with a communication endpoint provided by the second node or a proxy for the second node, determine an existing connection, and/or use a connectionless protocol such as UDP to send the message. In one embodiment, more than one message transmitter 206 can be provided based on, for example, protocols supported, message payload formats, recipients, and/or security requirements.

For example, in the media player 300 or in the media service 500, the message transmitter 306, 506 can receive the message generated by one or more content handlers 304, 504, and can be configured to prepare the message for transmission according to a particular application protocol, such as HTTP or one of its derivative protocols such as SOAP, XMPP or one of its derivative protocols such as the presence protocol included in XMPP-IM, or any suitable application protocol. Alternatively, the message transmitter 306, 506 can be configured to prepare the message for transmission according to a network protocol such as TCP, UDP, or any other protocol suitable for transmitting data between a first node and a second node. Thus, the message can be a response to a request for the message, an asynchronous, unsolicited message, and/or a notification associated with a subscription for receiving the message.

Preparation of the message can include breaking the message into packets, adding a header, adding a trailer, compressing or otherwise encoding the message data for transmission, encrypting, and/or managing session or state information. In various alternatives, some of the described processing can be performed by components other than the message transmitter 306, 506. For example, a TCP layer in a network stack in the network subsystem 324, 524 can handle breaking a message into packets if required by the length of the message. The message transmitter 306, 506 can be configured to interoperate with the network subsystem 324, 524 to send the message over the network 406 for delivery to the second node.

As indicated above, the second node can be any node accessible by the first node. For example, the first player node 402 can receive the message from the media storage node 408, the multicast server node 410, the CDN node 412, the second player node 404, and/or any other node operatively coupled to the network 406. Similarly, the media storage node 408 can receive a message from the first player node 402, the multicast streaming node 410, the CDN node 412, the second player node 404, and/or any other node operatively coupled to the network 406. According to an exemplary embodiment, when the message is received, the second (receiving) node can be configured to adjust the processing of a second media steam based on the content of the message as described above.

The embodiments described above can be used in many situations. For example, a recorder node or script in the recorder node can detect suspicious activity in a live media stream related to security of a facility. In response to detecting the suspicious activity in the live media stream, a message can be sent to other recorder nodes processing other media streams around and/or in the facility with information related to the activity to raise the sensitivity of the other recorder nodes to detect additional and/or coordinated activities in the other media streams around and/or in the facility. In response to receiving the message, the other recorder nodes can adjust processing of the other media streams.

It should be understood that the various components illustrated in the various block diagrams represent logical components that are configured to perform the functionality described herein and may be implemented in software, hardware, or a combination of the two. Moreover, some or all of these logical components may be combined, some may be omitted altogether, and additional components can be added while still achieving the functionality described herein. Thus, the subject matter described herein can be embodied in many different variations, and all such variations are contemplated to be within the scope of what is claimed.

To facilitate an understanding of the subject matter described above, many aspects are described in terms of sequences of actions that can be performed by elements of a computer system. For example, it will be recognized that the various actions can be performed by specialized circuits or circuitry (e.g., discrete logic gates interconnected to perform a specialized function), by program instructions being executed by one or more processors, or by a combination of both.

Moreover, the methods described herein can be embodied in executable instructions stored in a computer readable medium for use by or in connection with an instruction execution machine, system, apparatus, or device, such as a computer-based or processor-containing machine, system, apparatus, or device. As used here, a “computer readable medium” can include one or more of any suitable media for storing the executable instructions of a computer program in one or more of an electronic, magnetic, optical, electromagnetic, and infrared form, such that the instruction execution machine, system, apparatus, or device can read (or fetch) the instructions from the computer readable medium and execute the instructions for carrying out the described methods. A non-exhaustive list of conventional exemplary computer readable medium includes: a portable computer diskette; a random access memory (RAM); a read only memory (ROM); an erasable programmable read only memory (EPROM or Flash memory); optical storage devices, including a portable compact disc (CD), a portable digital video disc (DVD), a high definition DVD (HD-DVD™), a Blu-ray™ disc; and the like.

Thus, the subject matter described herein can be embodied in many different forms, and all such forms are contemplated to be within the scope of what is claimed. It will be understood that various details of the invention may be changed without departing from the scope of the claimed subject matter. Furthermore, the foregoing description is for the purpose of illustration only, and not for the purpose of limitation, as the scope of protection sought is defined by the claims as set forth hereinafter together with any equivalents thereof entitled to.

What is claimed is:

1. A method for processing a media stream, the method comprising:
detecting, in a first node processing a first media stream, information in the first media stream instructing the first node to listen for a message to be received from a second node;
receiving the message from the second node; and
adjusting processing of the first media stream based on the received message.

2. The method of claim 1 wherein the second node is processing a second media stream.

3. The method of claim 2 wherein the first media stream and the second media stream are instances of a same stream.

4. The method of claim 1 wherein the detected information includes at least one of an executable instruction and a non-executable indication.

5. The method of claim 4 further comprising processing at least one of the executable instruction and the non-executable indication in the detected information to instruct the first node to at least one of establish a subscription, send a request message, and open a communication endpoint for listening for the message from the second node.

6. The method of claim 1 wherein the detecting comprises executing by the first node at least one of an instruction included in the first media stream and an instruction included in a component of the first node.

7. The method of claim 1 wherein the detected information includes information identifying at least one of message content, message format, an attribute of time relating to the receiving of the message, and the second node.

8. The method of claim 1 wherein the adjusting processing of the first media stream based on the received message is further based on at least one of a sender of the message, a content type of a portion of the message, an attribute of the first media stream, and a user.

9. The method of claim 1 wherein adjusting processing of the first media stream includes altering presentable content of the first media stream by at least one of presenting content included in the received message; one of terminating and pausing the processing of the first media stream; changing a rate of processing; and altering a source of the first media stream.

10. A method for processing a media stream, the method comprising:
detecting, in a first node processing a first media stream, information in the first media stream instructing the first node to send a message to a second node;
generating the message in response to detecting the information; and
sending the message to the second node.

11. The method of claim 10 wherein the detected information includes at least one of an instruction and a non-executable indication.

12. The method of claim 10 further comprising processing the detected information to at least one of specify and evaluate an expression including a variable identifying a value based on at least one of a content of the first media stream and a received input, wherein at least one of generating the message and sending the message is based on an evaluation of the expression with the variable set to the identified value.

13. The method of claim 10 wherein the detected information includes information identifying at least one of message content, message format, an attribute of time relating to at least one of the generating of the message and the sending of the message, and the second node.

14. The method of claim 10 wherein detecting the information comprises executing by the first node at least one of an instruction included in the first media stream and an instruction included in a component of the first node.

15. The method of claim 10 wherein the second node is processing a second media stream, and wherein the message includes information for altering the processing of the second media stream.

16. A computer readable medium containing a computer program, executable by a machine, for processing a media stream, the computer program comprising executable instructions for:
detecting, in a first node processing a first media stream, information in the first media stream instructing the first node to listen for a message to be received from a second node;
receiving the message from the second node; and
adjusting processing of the first media stream based on the received message.

17. A system for processing a media stream, the system comprising:
means for detecting, in a first node processing a first media stream, information in the first media stream instructing the first node to listen for a message to be received from a second node;
means for receiving the message from the second node; and
means for adjusting processing of the first media stream based on the received message.

18. A system for processing a media stream, the system comprising:
a media processing module configured to detect, in a first node processing a first media stream, information in the first media stream instructing the first node to listen for a message to be received from a second node;
a message receiver configured to receive the message from the second node; and
a content handler component configured to adjust processing of the first media stream based on the received message.

19. The system of claim 18 wherein the second node is processing a second media stream.

20. The system of claim 18 wherein the first media stream and the second media stream are instances of a same stream.

21. The system of claim 18 wherein the detected information includes at least one of an executable instruction and a non-executable indication.

22. The system of claim 21 wherein the content handler component is configured to process at least one of the executable instruction and the non-executable indication in the detected information to instruct the first node to at least one of establish a subscription, send a request message, and open a communication endpoint for listening for the message from the second node.

23. The system of claim 18 wherein the media processing module is configured to execute at least one of an instruction included in the first media stream and an instruction included in a component of the first node.

24. The system of claim 18 wherein the detected information includes information identifying at least one of message content, message format, an attribute of time relating to the receiving of the message, and the second node.

25. The system of claim 18 wherein the content handler is configured to adjust processing of the first media stream based on at least one of a sender of the message, a content type of a portion of the message, an attribute of the first media stream, and a user.

26. The system of claim 18 wherein the content handler is further configured to alter presentable content of the first media stream by at least one of presenting content included in the received message; one of terminating and pausing the processing of the first media stream; changing a rate of processing; and altering a source of the first media stream.

27. A computer readable medium containing a computer program, executable by a machine, for processing a media stream, the computer program comprising executable instructions for:
detecting, in a first node processing a first media stream, information in the first media stream instructing the first node to send a message to a second node;
generating the message in response to detecting the information; and
sending the message to the second node.

28. A system for processing a media stream, the system comprising:
means for detecting, in a first node processing a first media stream, information in the first media stream instructing the first node to send a message to a second node;
means for generating the message in response to detecting the information; and
means for sending the message to the second node.

29. A system for processing a media stream, the system comprising:
a media processing module configured to detect, in a first node processing a first media stream, information in the first media stream instructing the first node to send a message to a second node;
a content handler component configured to generate the message in response to detecting the information; and
a message transmitter component configured to send the message to the second node.

30. The system of claim 29 wherein the detected information includes at least one of an instruction and a non-executable indication.

31. The system of claim 29 wherein the content handler component is further configured to process the detected information to at least one of specify and evaluate an expression including a variable identifying a value based on at least one of a content of the first media stream and a received input, wherein at least one of generating the message and sending the message is based on an evaluation of the expression with the variable set to the identified value.

32. The system of claim 29 wherein the detected information includes information identifying at least one of message content, message format, an attribute of time relating to at least one of the generating of the message and the sending of the message, and the second node.

33. The system of claim 29 wherein the media processing module is configured to execute at least one of an instruction included in the first media stream and an instruction included in a component of the first node.

34. The system of claim 29 wherein the second node is processing a second media stream, and wherein the message includes information for altering the processing of the second media stream.
